(19) United States
(12) Patent Application Publication
(10) Pub. No.: US 2026/0273592 A1
(43) Pub. Date: Sep. 17, 2026

(54) INTELLIGENT SUCTION-TYPE UNDERGROUND DRAINAGE PIPELINE SEDIMENT REMOVAL ROBOT AND SEDIMENT REMOVAL METHOD

(71) Applicant: Zhengzhou University, Zhengzhou (CN)

(72) Inventors: Hongyuan FANG, Zhengzhou (CN); Danyang DI, Zhengzhou (CN); Jinping ZHANG, Zhengzhou (CN); Yunfei WANG, Zhengzhou (CN); Bin SUN, Zhengzhou (CN)

(21) Appl. No.: 19/227,976

(22) Filed: Jun. 4, 2025

(30) Foreign Application Priority Data
Mar. 13, 2025 (CN) 202510298213.5

(51) Int. Cl. B08B 9/049; F16L 55/40; F16L 101/12

(52) U.S. Cl. CPC B08B 9/0492; F16L 55/40; B08B 2209/04; F16L 2101/12

(57) ABSTRACT

The present invention belongs to the field of sediment removal robots, and in particular, discloses an intelligent suction-type underground drainage pipeline sediment removal robot and a sediment removal method. The sediment removal robot includes an in-pipe integrated robot and a manhole box. The in-pipe integrated robot includes a hardware structure and a software module. The hardware structure includes a mechanical assembly, a circuit assembly, a sediment crushing assembly, a sediment conveying assembly, and a main body. The software module includes an intelligent pipeline siltation diagnosis module. Siltation diagnosis is achieved by embedding a drainage pipeline siltation diagnosis module based on a deep learning network into a deep learning development board, and sediment removal operation instructions are sent to a nail-head electric hammer, a high-pressure water nozzle, a sediment-crushing cutter, a sludge suction pipe, a sludge discharge pipe, and a vacuum sewage suction pump by using a central instruction transceiver module.

### TECHNICAL FIELD

The present invention relates to the field of sediment removal robots, and in particular, to an intelligent suction-type underground drainage pipeline sediment removal robot and a sediment removal method.

### BACKGROUND

Urban underground pipelines, covering water supply, drainage, gas, heat, electricity, communication, radio and television, and industrial pipelines and supporting facilities thereof, are key infrastructure to maintain operation of a city and are known as a “lifeline” of the city. On the one hand, with acceleration of urbanization, a number and a scale of underground pipelines continue to expand, and composition thereof becomes increasingly complex. On the other hand, due to long-term intensive use, the underground pipelines built earlier have exposed a large number of hidden dangers. In recent years, incidents such as urban flooding, road collapse, and pipeline bursts caused by underground pipeline network problems have occurred frequently, threatening people's lives and property. How to clean underground pipelines more effectively has become a major challenge facing current urban underground pipeline management.

The operation of the underground pipelines, especially patency, is extremely important. If blockage, poor drainage, and other problems occur, great trouble may be caused to people's normal work and life. However, environments inside the pipelines are complex and sewage composition is complex, so cleaning inside the pipelines is extremely unsuitable for manual labor. With rapid development and wide application of a robotics technologies, especially in some special environments or environments that are not suitable for human work, using robots to replace humans to complete dangerous or difficult tasks has become the forefront of engineering practice. Pipeline adaptive robots have high cleaning efficiency and good adaptability, which are more advantageous than existing robots. However, current pipeline sediment removal robots generally have poor cleaning efficiency and cannot adapt to complex conditions inside pipes.

### SUMMARY

To solve the problems existing in the prior art, the present invention provides an intelligent suction-type underground drainage pipeline sediment removal robot and a sediment removal method, which can realize automated and intelligent operation of siltation diagnosis and sediment removal of underground drainage pipeline networks in a certain maintenance area, greatly improve efficiency, eliminate a need for personnel to enter pipelines, and greatly reduce risks, thereby solving the problems mentioned in the Background.

To achieve the above objective, the present invention provides the following technical solution: an intelligent suction-type underground drainage pipeline sediment removal robot, wherein the sediment removal robot includes an in-pipe integrated robot and a manhole box; the in-pipe integrated robot including a hardware structure and a software module, the hardware structure of the in-pipe integrated robot including a mechanical assembly, a circuit assembly, a sediment crushing assembly, a sediment conveying assembly, and a main body, and the software module of the in-pipe integrated robot including an intelligent pipeline siltation diagnosis module;
wherein a plurality of mechanical assemblies are provided and are centrally symmetrically arranged on an outer housing of the main body with a central axis of the main body as a symmetry center, and the mechanical assembly includes a telescopic rod, a driving wheel, and a driven wheel, both the driving wheel and the driven wheel being fixed to the outer housing of the main body through the telescopic rod.

Preferably, the sediment crushing assembly includes a nail-head electric hammer, a high-pressure water nozzle, and a sediment-crushing cutter that are arranged on the main body; the nail-head electric hammer being arranged on a metal sliding groove in a center of a front part of the main body and being capable of left-right and front-back movement; the high-pressure water nozzle being arranged at a front end of a bottom part of the main body, and the sediment-crushing cutter being arranged on an annular metal sliding groove in a center of the bottom part of the main body, being capable of performing annular movement at a lower part of the main body, including a plurality of serrated blades, being capable of extending up and down, and having an overall circular shape.

Preferably, the sediment conveying assembly includes a sludge suction pipe, a sludge discharge pipe, and a vacuum sewage suction pump, the sludge suction pipe being arranged at a rear end of a bottom part of the main body, the sludge discharge pipe being arranged in a center of a rear part of a housing of the main body, and the vacuum sewage suction pump being arranged at a rear position inside the main body; the vacuum sewage suction pump having a front end connected to the sludge suction pipe and a rear end connected to the sludge discharge pipe to convey crushed in-pipe sludge externally.

Preferably, the circuit assembly includes a ranging radar, a central instruction transceiver module, a three-axis gyroscope, a deep learning development board, and an aviation plug-in interface, the ranging radar being arranged at an upper position of a front part of the main body, the aviation plug-in interface being arranged at an upper position of a rear part of the main body, and the central instruction transceiver module, the three-axis gyroscope, and the deep learning development board being arranged inside the main body.

Preferably, the central instruction transceiver module is responsible for controlling a motor configured to control a driving pulley, the three-axis gyroscope configured for attitude control, the ranging radar, the metal sliding groove, the annular metal sliding groove, the high-pressure water nozzle, and the vacuum sewage suction pump; and
the three-axis gyroscope is configured to measure and sense a motion state of the in-pipe integrated robot for attitude adjustment by the central instruction transceiver module.

Preferably, the intelligent pipeline siltation diagnosis module uses a stacked sparse autoencoder and a logistic regression classifier as intelligent pipeline siltation diagnosis algorithms, and takes drainage pipeline flow characteristic index data as input and a siltation length and a siltation thickness of a drainage pipeline as output; and the intelligent pipeline siltation diagnosis module runs on a deep learning development board, the deep learning development board outputting a pipeline siltation diagnosis result and transmitting the pipeline siltation diagnosis result to a central instruction transceiver module of the in-pipe integrated robot.

Preferably, the manhole box includes a box body, a box cover, a fixing claw, a lithium battery, a pipeline non-contact liquid level meter, a 4G wireless communication module, a whip transmitting antenna, and a floating towing cable; the lithium battery, the 4G wireless communication module, the pipeline non-contact liquid level meter, and the whip transmitting antenna being all mounted and fixed inside the box body.

Preferably, the 4G wireless communication module is configured to receive flow characteristic index data sent by a ground control console, and transmit flow characteristic index data of a drainage pipeline to the intelligent pipeline siltation diagnosis module of the in-pipe integrated robot, which is taken as data input for an intelligent pipeline siltation diagnosis algorithm.

Preferably, the whip transmitting antenna is connected to the 4G wireless communication module to upload and download 4G wireless data; the floating towing cable has one end connected to the pipeline non-contact liquid level meter, the lithium battery, the 4G wireless communication module, and a ground water source and the other end connected to the aviation plug-in interface; and the box body and the box cover are fixed to a wall of a manhole through the fixing claw.

On the other hand, to achieve the above objective, the present invention further provides the following technical solution: a sediment removal method based on the intelligent suction-type underground drainage pipeline sediment removal robot, including the following steps:
step S101: transmitting, by the 4G wireless communication module, received pipeline inlet/outlet flow velocity/flow rate data to the deep learning development board of the in-pipe integrated robot;
step S102: taking, by the intelligent pipeline siltation diagnosis module of the in-pipe integrated robot, the pipeline inlet/outlet flow velocity/flow rate data in step S101 as input, running on the deep learning development board of the in-pipe integrated robot, and outputting a pipeline siltation diagnosis result; wherein when a siltation depth is greater than or equal to one-fourth of a pipe diameter, the pipeline siltation diagnosis result indicating that siltation occurs is outputted, and sediment removal is required; and when the siltation depth is less than one-fourth of the pipe diameter, the pipeline siltation diagnosis result indicates that siltation does not occur, and sediment removal is not required;
step S103: transmitting, by the intelligent pipeline siltation diagnosis module of the in-pipe integrated robot, the pipeline siltation diagnosis result to the central instruction transceiver module of the in-pipe integrated robot; wherein when the pipeline siltation diagnosis result indicating that siltation occurs is outputted, the central instruction transceiver module controls the driving wheel and the telescopic rod of the in-pipe integrated robot to move in an underground drainage pipeline, and during the movement, the central instruction transceiver module simultaneously activates the high-pressure water nozzle, the sediment-crushing cutter, the annular metal sliding groove, the sludge suction pipe, the sludge discharge pipe, and the vacuum sewage suction pump to perform coordinated sediment removal;
step S104: during the movement of the in-pipe integrated robot, detecting, by the ranging radar of the in-pipe integrated robot, in real time whether there is pipeline sediment higher than the sediment-crushing cutter of the in-pipe integrated robot;
step S105: if the ranging radar detects in real time that there is pipeline sediment higher than the sediment-crushing cutter of the in-pipe integrated robot and a distance therebetween is less than 10 cm, controlling, by the central instruction transceiver module of the in-pipe integrated robot, the driving wheel to stop moving forward, and transmitting an operating instruction to the nail-head electric hammer at the same time;
step S106: after the nail-head electric hammer receives the operating instruction sent by the central instruction transceiver module, moving vertically and horizontally by using the metal sliding groove, hammering the pipeline sediment to crush the pipeline sediment into small pieces of sediment, and then further crushing, by the sediment-crushing cutter, the small pieces of sediment into fine particles; and
step S107: spraying, by the high-pressure water nozzle by using water flow, the fine particles obtained by crushing by the sediment-crushing cutter, sucking, by the vacuum sewage suction pump, a mixed fluid of the water flow and the fine particles into a ground sediment removal container through the sludge suction pipe and the sludge discharge pipe, and repeating the above steps to complete sediment removal of the underground drainage pipeline.

The present invention achieves the following beneficial effects. In the present invention, the sediment removal robot analyzes data and issues instructions through the central instruction transceiver module mounted on the robot, allowing a mechanical device to move adaptively in the pipeline, pushes sediment through the nail-head electric hammer, sprays water through the high-pressure water nozzle, crushes the sediment through the sediment-crushing cutter, and finally pumps out sludge through the sludge suction pipe to achieve a sediment removal effect. The present invention can achieve efficient pipeline sediment removal, which is higher in efficiency, lower in labor cost, and lower in safety risk than existing pipeline sediment removal machines.

### BRIEF DESCRIPTION OF DRAWINGS

FIG. 1 is an assembly diagram of an in-pipe integrated robot according to an embodiment of the present invention;

FIG. 2 is a side view of the in-pipe integrated robot according to an embodiment of the present invention;

FIG. 3 is a bottom view of the in-pipe integrated robot according to an embodiment of the present invention;

FIG. 4 is a front view of the in-pipe integrated robot according to an embodiment of the present invention;

FIG. 5 is a rear view of the in-pipe integrated robot according to an embodiment of the present invention;

FIG. 6 is a diagram of a hardware structure of a manhole box according to an embodiment of the present invention;

FIG. 7 is a diagram of a connection relationship between modules in the hardware structure of the manhole box according to an embodiment of the present invention; and

FIG. 8 is a diagram of a connection relationship between the in-pipe integrated robot and the manhole box according to an embodiment of the present invention.

In the drawings, 1: telescopic rod, 2: driving wheel, 3: driven wheel, 4: nail-head electric hammer, 5: high-pressure water nozzle, 6: sediment-crushing cutter, 7: sludge suction pipe, 8: sludge discharge pipe, 9: vacuum sewage suction pump, 10: ranging radar, 11: central instruction transceiver module, 12: three-axis gyroscope, 13: deep learning development board, 14: aviation plug-in interface, 15: metal sliding groove, 16: annular metal sliding groove, 17: box body, 18: box cover, 19: fixing claw, 20: lithium battery, 21: pipeline non-contact liquid level meter, 22: 4G wireless communication module, 23: whip transmitting antenna, 24: floating towing cable.

### DESCRIPTION OF EMBODIMENTS

The technical solutions in the embodiments of the present invention will be described clearly and completely below in conjunction with the accompanying drawings in the embodiments of the present invention. Obviously, the described embodiments are only some of rather than all of the embodiments of the present invention. Based on the embodiments of the present invention, all other embodiments obtained by those of ordinary skill in the art without creative efforts shall fall within the protection scope of the present invention.

It should be noted that, in the absence of conflict, implementations of the present invention and features of the implementations may be combined with each other. It should be noted that similar reference numerals and letters denote similar items in the following drawings, and therefore, once an item is defined in one drawing, further definition and explanation thereof is not required in subsequent drawings.

In the description of the present invention, it should be noted that the orientation or position relationships indicated by the terms “central”, “upper”, “lower”, “front”, “back”, “left”, “right”, “vertical”, “horizontal”, “inner”, “outer”, and the like are based on the orientation or position relationships shown in the accompanying drawings, or are orientation or position relationships in which the invention product is usually placed when used, or are orientation or position relationships commonly understood by those skilled in the art, and are intended to facilitate the description of the present invention and simplify the description only, rather than indicating or implying that the apparatus or element referred to must have a particular orientation or be constructed and operated in a particular orientation, and therefore are not to be interpreted as limiting the present invention. In addition, the terms “first”, “second”, and the like are used for descriptive purposes only, which cannot be construed as indicating or implying a relative importance

In the description of the present invention, it should be further noted that unless otherwise specified and defined explicitly, the terms “arrange”, “mount”, “connect”, and “join” should be understood in a broad sense, which may be, for example, a fixed connection, a detachable connection, or an integral connection; a mechanical connection or an electrical connection; or a direct connection, an indirect connection via an intermediate medium, or an internal connection between two elements. Those of ordinary skill in the art can understand specific meanings of these terms in the present invention according to specific situations.

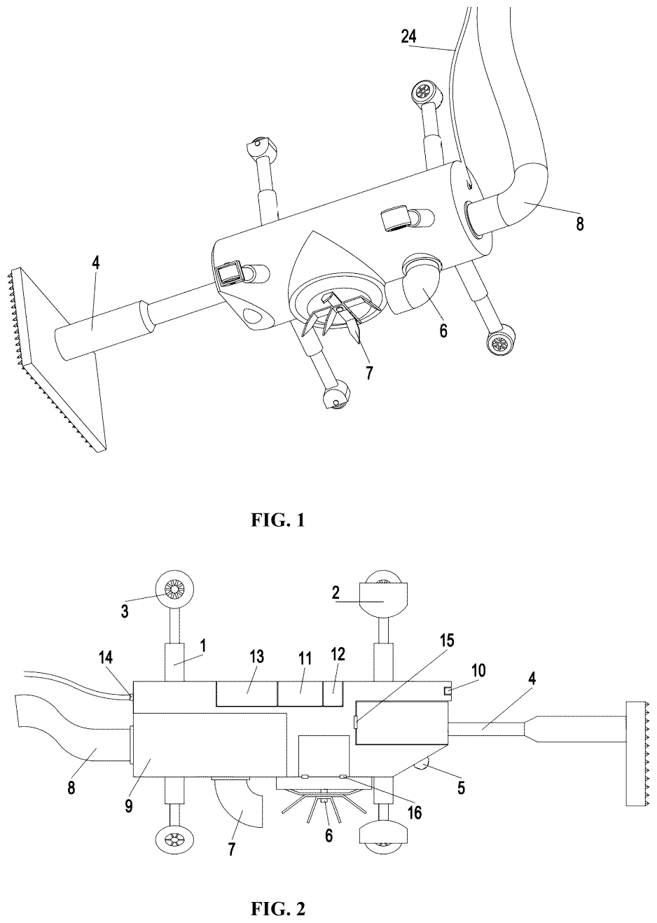

Referring to FIG. 1 to FIG. 8, the present invention provides a technical solution: an intelligent suction-type underground drainage pipeline sediment removal robot. As shown in FIG. 8, the sediment removal robot includes an in-pipe integrated robot and a manhole box; the in-pipe integrated robot includes a hardware structure and a software module, the hardware structure of the in-pipe integrated robot includes a mechanical assembly, a circuit assembly, a sediment crushing assembly, a sediment conveying assembly, and a main body, and the software module of the in-pipe integrated robot includes an intelligent pipeline siltation diagnosis module.

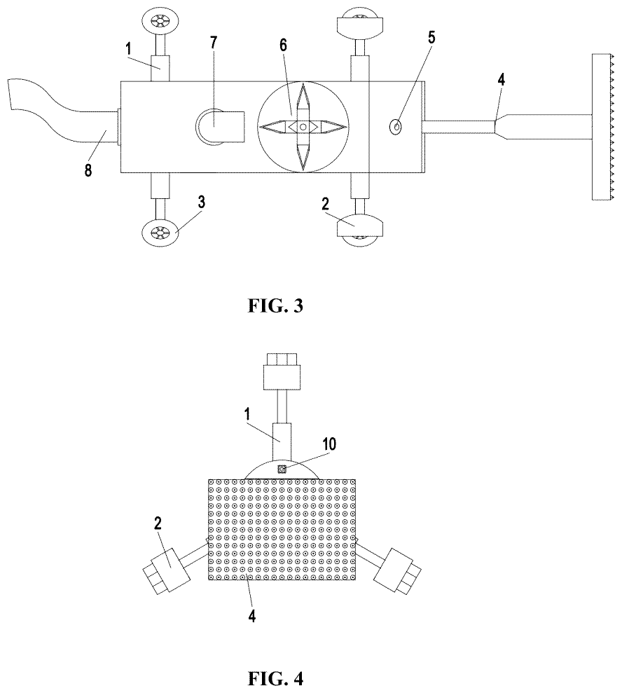

As shown in FIG. 2 and FIG. 3, a plurality of mechanical assemblies are provided and are centrally symmetrically arranged on an outer housing of the main body with a central axis of the main body as a symmetry center, the mechanical assembly includes a telescopic rod 1, a driving wheel 2, and a driven wheel 3, and both the driving wheel 2 and the driven wheel 3 are fixed to the outer housing of the main body through the telescopic rod 1.

Further, three mechanical assemblies are provided, each of which includes a driving wheel 2 arranged in the front and a driven wheel 3 arranged in the back. The driving wheel 2 may adjust a direction mechanically and automatically through a motor to perform circumferential rotation, thereby driving the in-pipe integrated robot to move forward and avoid obstacles.

As shown in FIG. 1, the sediment crushing assembly includes a nail-head electric hammer 4, a high-pressure water nozzle 5, and a sediment-crushing cutter 6 that are arranged on the main body. As shown in FIG. 4, the nail-head electric hammer 4 is arranged on a metal sliding groove 15 in a center of a front part of the main body and is capable of left-right and front-back movement; the high-pressure water nozzle 5 is arranged at a front end of a bottom part of the main body, and the sediment-crushing cutter 6 is arranged on an annular metal sliding groove 16 in a center of the bottom part of the main body, is capable of performing annular movement at a lower part of the main body, includes a plurality of serrated blades, is capable of extending up and down, and has an overall circular shape.

The high-pressure water nozzle 5 may simultaneously provide high-pressure flushing for crushing actions of the nail-head electric hammer 4 and the sediment-crushing cutter 6 to crush the sediment, making it convenient for the sludge suction pipe 7, the sludge discharge pipe 8, and the vacuum sewage suction pump 9 to pump the crushed sediment out of the drainage pipeline.

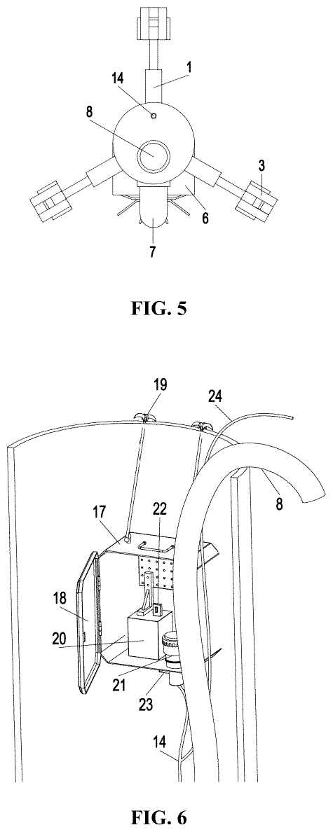

As shown in FIG. 5, the sediment conveying assembly includes a sludge suction pipe 7, a sludge discharge pipe 8, and a vacuum sewage suction pump 9, the sludge suction pipe 7 is arranged at a rear end of a bottom part of the main body, the sludge discharge pipe 8 is arranged in a center of a rear part of a housing of the main body, and the vacuum sewage suction pump 9 is arranged at a rear position inside the main body.

The vacuum sewage suction pump 9 has a front end connected to the sludge suction pipe 7 and a rear end connected to the sludge discharge pipe 8 to convey crushed in-pipe sludge externally.

As shown in FIG. 2, the circuit assembly includes a ranging radar 10, a central instruction transceiver module 11, a three-axis gyroscope 12, a deep learning development board 13, and an aviation plug-in interface 14, the ranging radar 10 is arranged at an upper position of a front part of the main body, the aviation plug-in interface 14 is arranged at an upper position of a rear part of the main body, and the central instruction transceiver module 11, the three-axis gyroscope 12, and the deep learning development board 13 are arranged inside the main body.

The central instruction transceiver module 11 is responsible for controlling a motor configured to control a driving pulley, the three-axis gyroscope 12 configured for attitude control, the ranging radar 10, the metal sliding groove 15, the annular metal sliding groove 16, the high-pressure water nozzle 5, and the vacuum sewage suction pump 9.

The three-axis gyroscope 12 is configured to measure and sense a motion state of the in-pipe integrated robot for attitude adjustment by the central instruction transceiver module 11.

The intelligent pipeline siltation diagnosis module uses a stacked sparse autoencoder and a logistic regression classifier as intelligent pipeline siltation diagnosis algorithms, and takes drainage pipeline flow characteristic index data as input and a siltation length and a siltation thickness of a drainage pipeline as output. The intelligent pipeline siltation diagnosis module runs on the deep learning development board 13, and the deep learning development board 13 outputs a pipeline siltation diagnosis result and transmits the pipeline siltation diagnosis result to the central instruction transceiver module 11 of the in-pipe integrated robot.

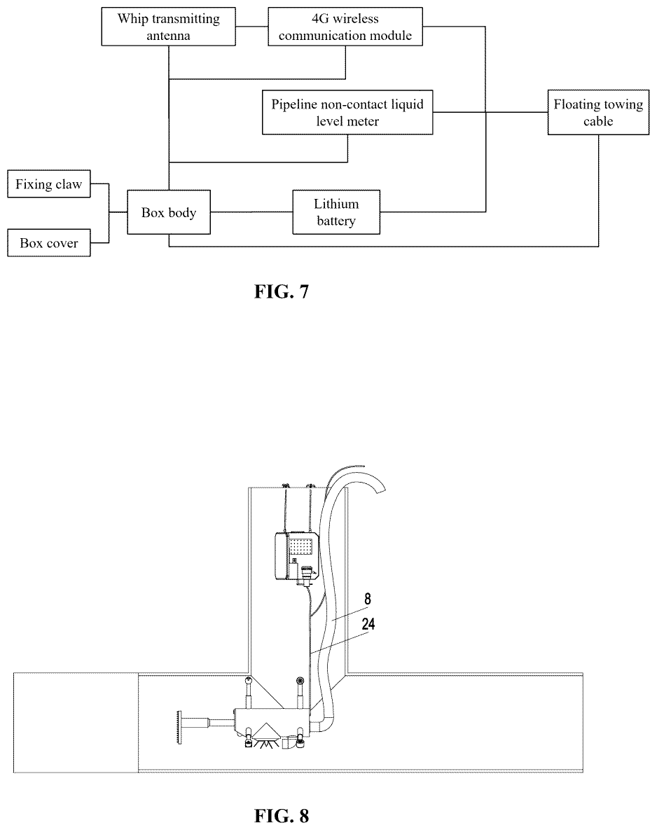

As shown in FIG. 6 and FIG. 7, the manhole box includes a box body 17, a box cover 18, a fixing claw 19, a lithium battery 20, a pipeline non-contact liquid level meter 21, a 4G wireless communication module 22, a whip transmitting antenna 23, and a floating towing cable 24; and the lithium battery 20, the 4G wireless communication module 22, the pipeline non-contact liquid level meter 21, and the whip transmitting antenna 23 are all mounted and fixed inside the box body 17.

The intelligent suction-type underground drainage pipeline sediment removal robot may be powered by an external power supply. When the external power supply is abnormal, the manhole box automatically switches to the lithium battery 20 for power supply, realizing dual-path redundancy of the power supply system.

The 4G wireless communication module 22 is configured to receive flow characteristic index data sent by a ground control console, and transmit flow characteristic index data of a drainage pipeline to the intelligent pipeline siltation diagnosis module of the in-pipe integrated robot, which is taken as data input for an intelligent pipeline siltation diagnosis algorithm.

The whip transmitting antenna 23 is connected to the 4G wireless communication module 22 to upload and download 4G wireless data.

As shown in FIG. 8, the floating towing cable 24 has one end connected to the pipeline non-contact liquid level meter 21, the lithium battery 20, the 4G wireless communication module 22, and a ground water source and the other end connected to the aviation plug-in interface 14.

The box body 17 and the box cover 18 are fixed to a wall of a manhole through the fixing claw 19.

Based on a same inventive concept as the above method embodiment, a sediment removal method for pipeline sediment removal by using the intelligent suction-type underground drainage pipeline sediment removal robot is provided, including the following steps:
step S101: transmitting, by the 4G wireless communication module 22, received pipeline inlet/outlet flow velocity/flow rate data to the deep learning development board 13 of the in-pipe integrated robot;
step S102: taking, by the intelligent pipeline siltation diagnosis module of the in-pipe integrated robot, the pipeline inlet/outlet flow velocity/flow rate data in step S101 as input, running on the deep learning development board of the in-pipe integrated robot, and outputting a pipeline siltation diagnosis result; wherein when a siltation depth is greater than or equal to one-fourth of a pipe diameter, the pipeline siltation diagnosis result indicating that siltation occurs is outputted, and sediment removal is required; and when the siltation depth is less than one-fourth of the pipe diameter, the pipeline siltation diagnosis result indicates that siltation does not occur, and sediment removal is not required;
step S103: transmitting, by the intelligent pipeline siltation diagnosis module of the in-pipe integrated robot, the pipeline siltation diagnosis result to the central instruction transceiver module 11 of the in-pipe integrated robot; wherein when the pipeline siltation diagnosis result indicating that siltation occurs is outputted, the central instruction transceiver module 11 controls the driving wheel 2 and the telescopic rod 1 of the in-pipe integrated robot to move in an underground drainage pipeline, and during the movement, the central instruction transceiver module 11 simultaneously activates the high-pressure water nozzle 5, the sediment-crushing cutter 6, the annular metal sliding groove 16, the sludge suction pipe 7, the sludge discharge pipe 8, and the vacuum sewage suction pump 9 to perform coordinated sediment removal;
step S104: during the movement of the in-pipe integrated robot, detecting, by the ranging radar 10 of the in-pipe integrated robot, in real time whether there is pipeline sediment higher than the sediment-crushing cutter 6 of the in-pipe integrated robot;
step S105: if the ranging radar 10 detects in real time that there is pipeline sediment higher than the sediment-crushing cutter 6 of the in-pipe integrated robot and a distance therebetween is less than 10 cm, controlling, by the central instruction transceiver module 11 of the in-pipe integrated robot, the driving wheel 2 to stop moving forward, and transmitting an operating instruction to the nail-head electric hammer 4 at the same time;
step S106: after the nail-head electric hammer 4 receives the operating instruction sent by the central instruction transceiver module 11, moving vertically and horizontally by using the metal sliding groove 15, hammering the pipeline sediment to crush the pipeline sediment into small pieces of sediment, and then further crushing, by the sediment-crushing cutter 6, the small pieces of sediment into fine particles; and
step S107: spraying, by the high-pressure water nozzle 5 by using water flow, the fine particles obtained by crushing by the sediment-crushing cutter 6, sucking, by the vacuum sewage suction pump 9, a mixed fluid of the water flow and the fine particles into a ground sediment removal container through the sludge suction pipe 7 and the sludge discharge pipe 8, and repeating the above steps to complete sediment removal of the underground drainage pipeline.

Although the present invention is described in detail with reference to the foregoing embodiments, those of ordinary skill in the art may still make modifications to the technical solutions described in the foregoing embodiments or make equivalent replacements to some technical features thereof. Any modifications, equivalent replacements, improvements, and the like made within the spirit and principles of the present invention should fall within the protection scope of the present invention.

What is claimed is:

1. An intelligent suction-type underground drainage pipeline sediment removal robot, wherein the sediment removal robot comprises an in-pipe integrated robot and a manhole box; the in-pipe integrated robot comprising a hardware structure and a software module, the hardware structure of the in-pipe integrated robot comprising a mechanical assembly, a circuit assembly, a sediment crushing assembly, a sediment conveying assembly, and a main body, and the software module of the in-pipe integrated robot comprising an intelligent pipeline siltation diagnosis module;
wherein a plurality of mechanical assemblies are provided and are centrally symmetrically arranged on an outer housing of the main body with a central axis of the main body as a symmetry center, and the mechanical assembly comprises a telescopic rod (1), a driving wheel (2), and a driven wheel (3), both the driving wheel (2) and the driven wheel (3) being fixed to the outer housing of the main body through the telescopic rod (1).

2. The intelligent suction-type underground drainage pipeline sediment removal robot according to claim 1, wherein the sediment crushing assembly comprises a nail-head electric hammer (4), a high-pressure water nozzle (5), and a sediment-crushing cutter (6) that are arranged on the main body; the nail-head electric hammer (4) being arranged on a metal sliding groove (15) in a center of a front part of the main body and being capable of left-right and front-back movement; the high-pressure water nozzle (5) being arranged at a front end of a bottom part of the main body, and the sediment-crushing cutter (6) being arranged on an annular metal sliding groove (16) in a center of the bottom part of the main body, being capable of performing annular movement at a lower part of the main body, comprising a plurality of serrated blades, being capable of extending up and down, and having an overall circular shape.

3. The intelligent suction-type underground drainage pipeline sediment removal robot according to claim 1, wherein the sediment conveying assembly comprises a sludge suction pipe (7), a sludge discharge pipe (8), and a vacuum sewage suction pump (9), the sludge suction pipe (7) being arranged at a rear end of a bottom part of the main body, the sludge discharge pipe (8) being arranged in a center of a rear part of a housing of the main body, and the vacuum sewage suction pump (9) being arranged at a rear position inside the main body; the vacuum sewage suction pump (9) having a front end connected to the sludge suction pipe (7) and a rear end connected to the sludge discharge pipe (8) to convey crushed in-pipe sludge externally.

4. The intelligent suction-type underground drainage pipeline sediment removal robot according to claim 1, wherein the circuit assembly comprises a ranging radar (10), a central instruction transceiver module (11), a three-axis gyroscope (12), a deep learning development board (13), and an aviation plug-in interface (14), the ranging radar (10) being arranged at an upper position of a front part of the main body, the aviation plug-in interface (14) being arranged at an upper position of a rear part of the main body, and the central instruction transceiver module (11), the three-axis gyroscope (12), and the deep learning development board (13) being arranged inside the main body.

5. The intelligent suction-type underground drainage pipeline sediment removal robot according to claim 4, wherein the central instruction transceiver module (11) is responsible for controlling a motor configured to control a driving pulley, the three-axis gyroscope (12) configured for attitude control, the ranging radar (10), the metal sliding groove (15), the annular metal sliding groove (16), the high-pressure water nozzle (5), and the vacuum sewage suction pump (9); and
the three-axis gyroscope (12) is configured to measure and sense a motion state of the in-pipe integrated robot for attitude adjustment by the central instruction transceiver module (11).

6. The intelligent suction-type underground drainage pipeline sediment removal robot according to claim 1, wherein the intelligent pipeline siltation diagnosis module uses a stacked sparse autoencoder and a logistic regression classifier as intelligent pipeline siltation diagnosis algorithms, and takes drainage pipeline flow characteristic index data as input and a siltation length and a siltation thickness of a drainage pipeline as output; and the intelligent pipeline siltation diagnosis module runs on a deep learning development board (13), the deep learning development board (13) outputting a pipeline siltation diagnosis result and transmitting the pipeline siltation diagnosis result to a central instruction transceiver module (11) of the in-pipe integrated robot.

7. The intelligent suction-type underground drainage pipeline sediment removal robot according to claim 1, wherein the manhole box comprises a box body (17), a box cover (18), a fixing claw (19), a lithium battery (20), a pipeline non-contact liquid level meter (21), a 4G wireless communication module (22), a whip transmitting antenna (23), and a floating towing cable (24); the lithium battery (20), the 4G wireless communication module (22), the pipeline non-contact liquid level meter (21), and the whip transmitting antenna (23) being all mounted and fixed inside the box body (17).

8. The intelligent suction-type underground drainage pipeline sediment removal robot according to claim 7, wherein the 4G wireless communication module (22) is configured to receive flow characteristic index data sent by a ground control console, and transmit flow characteristic index data of a drainage pipeline to the intelligent pipeline siltation diagnosis module of the in-pipe integrated robot, which is taken as data input for an intelligent pipeline siltation diagnosis algorithm.

9. The intelligent suction-type underground drainage pipeline sediment removal robot according to claim 7, wherein the whip transmitting antenna (23) is connected to the 4G wireless communication module (22) to upload and download 4G wireless data; the floating towing cable (24) has one end connected to the pipeline non-contact liquid level meter (21), the lithium battery (20), the 4G wireless communication module (22), and a ground water source and the other end connected to the aviation plug-in interface (14); and the box body (17) and the box cover (18) are fixed to a wall of a manhole through the fixing claw (19).

10. A sediment removal method based on an intelligent suction-type underground drainage pipeline sediment removal robot, comprising the following steps:
step S101: transmitting, by the 4G wireless communication module (22), received pipeline inlet/outlet flow velocity/flow rate data to the deep learning development board (13) of the in-pipe integrated robot;
step S102: taking, by the intelligent pipeline siltation diagnosis module of the in-pipe integrated robot, the pipeline inlet/outlet flow velocity/flow rate data in step S101 as input, running on the deep learning development board of the in-pipe integrated robot, and outputting a pipeline siltation diagnosis result; wherein when a siltation depth is greater than or equal to one-fourth of a pipe diameter, the pipeline siltation diagnosis result indicating that siltation occurs is outputted, and sediment removal is required; and when the siltation depth is less than one-fourth of the pipe diameter, the pipeline siltation diagnosis result indicates that siltation does not occur, and sediment removal is not required;
step S103: transmitting, by the intelligent pipeline siltation diagnosis module of the in-pipe integrated robot, the pipeline siltation diagnosis result to the central instruction transceiver module (11) of the in-pipe integrated robot; wherein when the pipeline siltation diagnosis result indicating that siltation occurs is outputted, the central instruction transceiver module (11) controls the driving wheel (2) and the telescopic rod (1) of the in-pipe integrated robot to move in an underground drainage pipeline, and during the movement, the central instruction transceiver module (11) simultaneously activates the high-pressure water nozzle (5) the sediment-crushing cutter (6), the annular metal sliding groove (16), the sludge suction pipe (7), the sludge discharge pipe (8), and the vacuum sewage suction pump (9) to perform coordinated sediment removal;
step S104: during the movement of the in-pipe integrated robot, detecting, by the ranging radar (10) of the in-pipe integrated robot, in real time whether there is pipeline sediment higher than the sediment-crushing cutter (6) of the in-pipe integrated robot;
step S105: if the ranging radar (10) detects in real time that there is pipeline sediment higher than the sediment-crushing cutter (6) of the in-pipe integrated robot and a distance therebetween is less than 10 cm, controlling, by the central instruction transceiver module (11) of the in-pipe integrated robot, the driving wheel (2) to stop moving forward, and transmitting an operating instruction to the nail-head electric hammer (4) at the same time;
step S106: after the nail-head electric hammer (4) receives the operating instruction sent by the central instruction transceiver module (11), moving vertically and horizontally by using the metal sliding groove (15), hammering the pipeline sediment to crush the pipeline sediment into small pieces of sediment, and then further crushing, by the sediment-crushing cutter (6), the small pieces of sediment into fine particles; and
step S107: spraying, by the high-pressure water nozzle (5) by using water flow, the fine particles obtained by crushing by the sediment-crushing cutter (6), sucking, by the vacuum sewage suction pump (9), a mixed fluid of the water flow and the fine particles into a ground sediment removal container through the sludge suction pipe (7) and the sludge discharge pipe (8) and repeating the above steps to complete sediment removal of the underground drainage pipeline.
